(19) United States
(12) Patent Application Publication
(10) Pub. No.: US 2007/0038550 A1
(43) Pub. Date: Feb. 15, 2007

(54) Methods and systems for conditional auto trading

(75) Inventors: Barthelemy Caille, New York, NY (US); Gregoire Schneider, New York, NY (US); David Cushing, Lexington, MA (US); Tomas Bok, Somerville, MA (US); Joe Loftus, Little Silver, NJ (US); Mike Eckert, Madison, NJ (US); Joe Corcoran, Basking Ridge, NJ (US); Art Ayzerov, Paramus, NJ (US); Robert Saffer, Chappaqua, NY (US)

Correspondence Address: MORGAN LEWIS & BOCKIUS LLP, 1111 PENNSYLVANIA AVENUE NW, WASHINGTON, DC, 20004, US

(73) Assignee: Lehman Brothers Inc., New York, NY (US)

(21) Appl. No.: 11/387,994

(22) Filed: Mar. 22, 2006

Related U.S. Application Data
(60) Provisional application No. 60/664,079, filed on Mar. 22, 2005.

(51) Int. Cl. G06Q 40/00

(52) U.S. Cl. 705/37

(57) ABSTRACT

In at one aspect, the invention comprises an interactive software toolkit for creating custom trading strategies. Traders are provided with the ability to easily construct hybrid strategies using automated trading and event building blocks: (a) trading algorithms (for example, so-called “percentage of volume” algorithms and algorithms designed to minimize the difference between average executed price and standardized benchmarks such as volume-weighted average price (“VWAP”)); (b) intelligent “sweeps” (automated trading actions designed to rapidly execute a specified number of shares); and (c) event triggers (time-, price-, spread-, depth-based, or based on other real-time market data or on current order status). Traders can create and store a set of custom strategies tailored to specific order types or trading styles.

### CROSS-REFERENCE TO RELATED APPLICATIONS

This application claims the benefit of U.S. Provisional Application No. 60/664,079, filed Mar. 22, 2005. The entire contents of that provisional application are incorporated herein by reference.

### SUMMARY

In at least one aspect, the present invention is directed to systems and methods for enabling a user to have multiple trading strategies implemented automatically, with switching between strategies also implemented automatically and based upon user-selected conditions. The description herein should be understood to describe only certain embodiments of the invention. Those skilled in the art will recognize, for example, that one described embodiment is just one simplified example of an inventive system and method for a “strategy state machine” that enables users to specify multiple trading strategies that are implemented based upon various criteria.

In at least one aspect, the invention comprises an interactive software toolkit for creating custom trading strategies. Traders are provided with the ability to easily construct hybrid strategies using automated trading and event building blocks: (a) trading algorithms (for example, so-called “percentage of volume” algorithms and algorithms designed to minimize the difference between average executed price and standardized benchmarks such as volume-weighted average price (“VWAP”)); (b) intelligent “sweeps” (automated trading actions designed to rapidly execute a specified number of shares); and (c) event triggers (time-, price-, spread-, depth-based, or based on other real-time market data or on current order status). Traders can create and store a set of custom strategies tailored to specific order types or trading styles. The software (referred to herein for brevity as “Conditional Autotrader,” or “CAT”) provides an added degree of control over the execution process.

It is important to note that the term “algorithm” as used herein (and as used by those skilled in the automated trading strategy field) refers to an automated trading strategy, and not to a mathematical algorithm as such.

In at least one embodiment of the invention, a user is allowed to specify particular cycling logic. That is, a user may specify that strategy A should be implemented unless condition 1 occurs, during which time strategy B should be implemented (so that if condition 1 ceases to occur, the system switches back from strategy B to strategy A).

In one aspect, the invention comprises a computer system operable to display a graphical user interface comprising a time horizon component, a base action component, a condition component, and a conditional action component, wherein the time horizon component is operable to display a start time and an end time for a trading order for a security; the base action component is operable to display information identifying one or more automated trading strategies to be initially used to execute the order; the condition component is operable to display one or more market conditions for triggering one or more triggered strategies; and the conditional action component is operable to display information identifying one or more triggered strategies to be used to execute the order when triggered by the one or more market conditions.

In various embodiments: (a) the time horizon component comprises a time configuration tab display; (b) a default start time is immediately; (c) a default end time is time of market closing; (d) a one shot component that allows a user to specify that a transition from an action to a conditional action occurs only once; (e) the system further comprises a rest period component that displays at least a specified time period that an order must spend in each action after an action shift; (f) the system further comprises a rest period component that displays at least a specified time period that must elapse following completion of an action before it can occur again; (g) the base action component comprises an action tab; (h) the base action component is operable to display trading strategy choices comprising one or more of: VWAP, With Volume, Target Strike, TWAP, and Idle; (i) the market conditions comprise passage of time; (j) at least one of the trading strategy choices is displayed with a set of parameter options that can be used to set constraints and tailor execution style for the trading strategy; (k) the condition component comprises a condition tab; (l) the condition component is operable to display condition choices comprising one or more of: price condition, time condition, size on opposite side condition, and bid/ask spread condition, and wherein each condition has parameters that can be set; (m) the price condition is operable to trigger a conditional action when the security's price reaches a threshold level; (n) the time condition is operable to trigger a conditional action at a specified time; (o) the size on opposite side condition is operable to trigger a conditional action when at least a specified number of shares is available within a specified range of a midpoint of a bid/ask spread; (p) the bid/ask condition is operable to trigger a conditional action when a bid/ask spread is wider or narrower than a specified threshold level; (q) the conditional action component comprises a conditional action tab; (r) the conditional action component is operable to display conditional action choices comprising at least one of: VWAP, With Volume, Target Strike, TWAP, Idle, and Fast Exec, along with corresponding parameter settings; and (s) the Fast Exec condition comprises one or more of: a Limit Sweep condition and a 2 Minutes VWAP condition.

Those skilled in the art will recognize that the invention, in at least one aspect, is directed to providing an interface that allows traders to choose various combinations of trading strategies and implementation parameters. The invention does not depend on the particular events or trading strategies used, and is not limited to any particular combination of events or trading strategies. Moreover, since various automated trading strategies are known in the art, such strategies are not described in detail herein. The invention (at least in one aspect) lies in the interface described herein as well as an underlying software framework, which together allow for the creation, storage, and execution of complex trading strategies. Given that the interface presents to a user the methods and functions executed by the framework, the system is therefore enabled by describing the principles of operation of that interface.

Embodiments of the present invention comprise computer components and computer-implemented steps that will be apparent to those skilled in the art. For ease of exposition, not every step or element of the present invention is described herein as part of a computer system, but those skilled in the art will recognize that each step or element may have a corresponding computer system or software component. Such computer system and/or software components are therefore enabled by describing their corresponding steps or elements. (that is, their functionality), and are within the scope of the present invention.

### BRIEF DESCRIPTION OF THE DRAWINGS

FIGS. 1-3 depict a preferred CAT interface used to implement an exemplary trading strategy.

FIG. 4 depicts preferred usage of a Time Config Tab.

FIG. 5 depicts preferred usage of an Action Tab.

FIG. 6 depicts preferred usage of a Condition Tab Price Condition.

FIG. 7 depicts preferred usage of a Condition Tab Time Condition.

FIG. 8 depicts preferred usage of a Condition Tab Size on Opposite Side Condition.

FIG. 9 depicts preferred usage of a Condition Tab Bid/Ask Spread Condition.

FIG. 10 depicts preferred usage of a Conditional Action Tab.

FIG. 11 depicts preferred usage of Fast Exec under a Conditional Action Tab.

FIGS. 12-14 depict a preferred interface used in a “stealth target strike” trading strategy.

FIGS. 15-17 depict a preferred interface used in a “lurk and pounce” trading strategy.

FIGS. 18-20 depict a preferred interface used in a “With Volume (percent of volume strategy) with 3:45 PM clean-up” trading strategy.

FIGS. 21-23 depict a preferred interface used in a “scaled with volume” trading strategy.

FIGS. 24-26 depict a preferred interface used in yet another trading strategy.

FIG. 27 is a component diagram of an embodiment of the present invention.

FIG. 28 is flow diagram of an embodiment of the present invention.

### DETAILED DESCRIPTION OF PREFERRED EMBODIMENTS

CAT provides an advanced trading interface that enables users to easily build custom order execution strategies (also known as “trading strategies”) on the fly as well as a framework for representing, storing, and implementing (trading) these custom strategies. With CAT, users can customize standard trading strategies like VWAP or percentage of volume by adding contingency rules that instruct the strategy to deviate from the standard action under certain pre-defined conditions. Alternatively, users can create completely new hybrid strategies, drawing from a collection of automated trading building blocks. Many unique strategies can be built by specifying just a few parameters, giving a trader an unprecedented degree of control over the execution process.

Example: A trader is liquidating a position in a small market capitalization stock that trades in uneven frequency and quantity. She wants to participate more heavily when the market is more active and sit out any quieter periods. Additionally, she wants to proactively sweep the market whenever there is above-average depth available on the buy side of the order book within a four cent per share range of the mean of the bid-offer quotation (“bid-ask midpoint”).

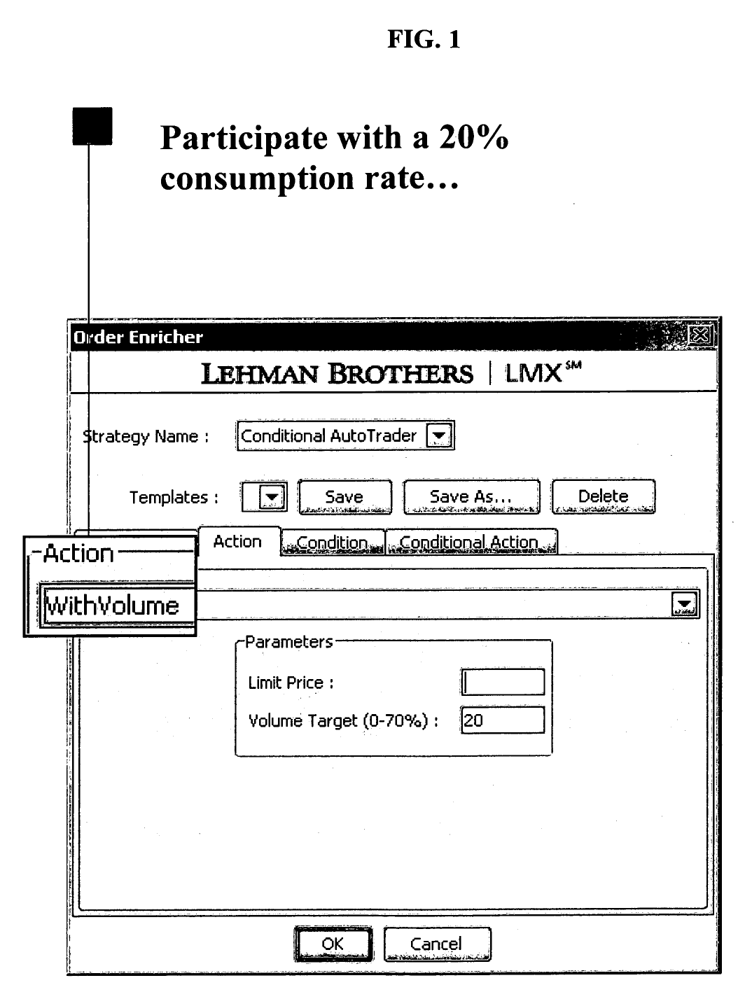

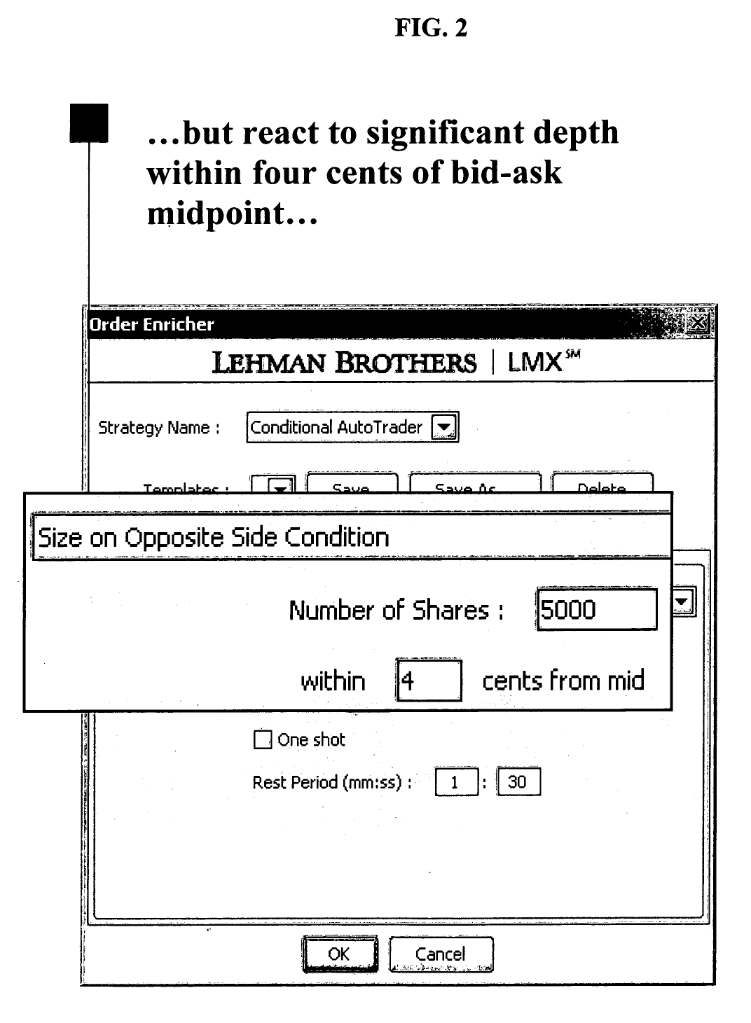

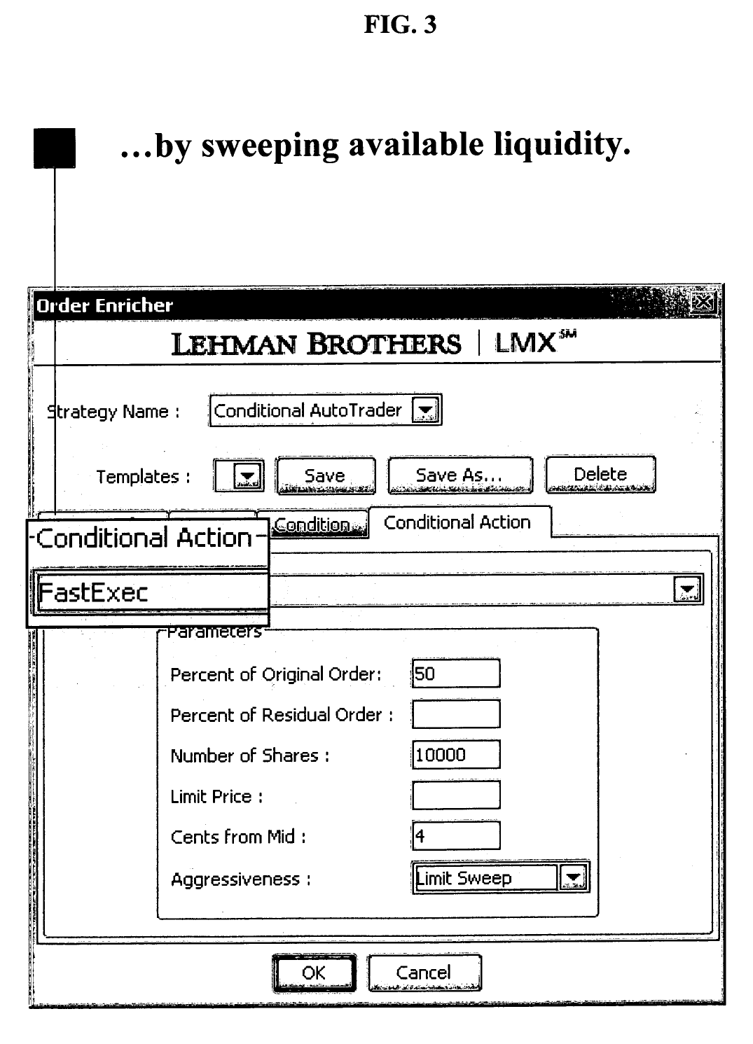

Thus, the trader decides to participate with 20 percent of volume (see FIG. 1), but react to significant depth within 4 cents of bid-ask midpoint (see FIG. 2) by sweeping available liquidity (see FIG. 3). These strategy terms are explained in detail below.

Preferred Structure of a CAT Order: Every CAT strategy preferably is made up of four components: (1) the Time Horizon for the order, consisting of start and end times; (2) the Base Action, the automated trading action that will initially be used to execute the order; (3) the Conditional Action, a second, “triggered” trading action that can be triggered under pre-defined market conditions; and (4) the Condition, the rule that governs when and how the conditional action will be triggered. Each of these components preferably is represented by a tab on the CAT interface.

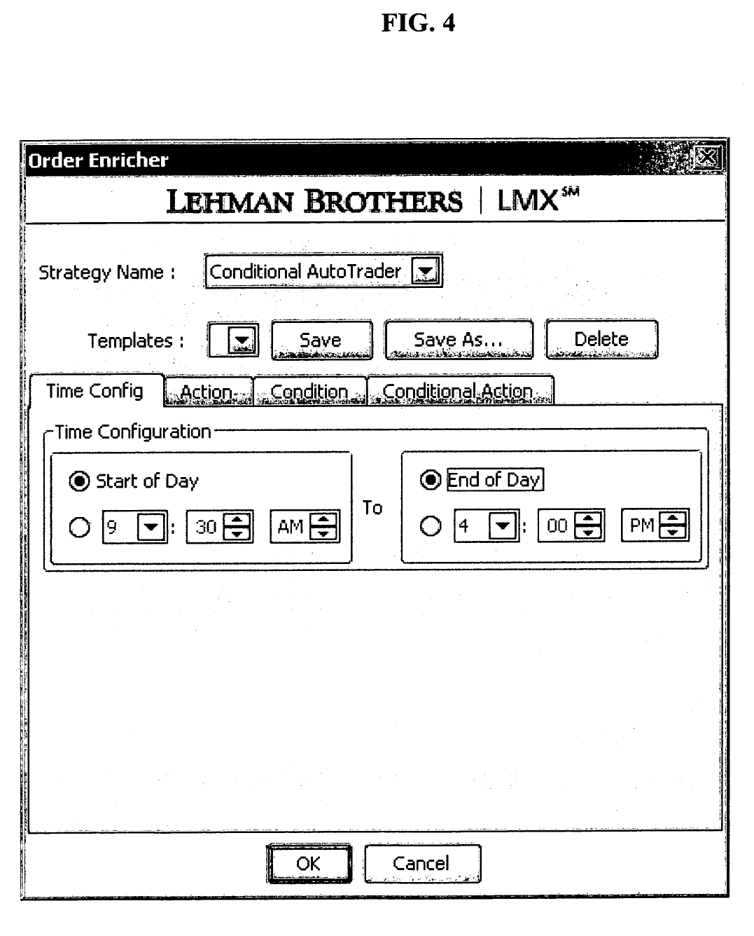

Time Config Tab: See FIG. 4. The controls on this tab are used to select the time horizon of a user's CAT order. By default, the order will commence trading immediately (but waiting until the market opens, if necessary) and will trade until the market close time. A user may enter different start or end times. The time horizon settings affect the entire order, both the base action and the conditional action. If the order has not completed at the specified end time, the order will expire and any unexecuted shares will be returned.

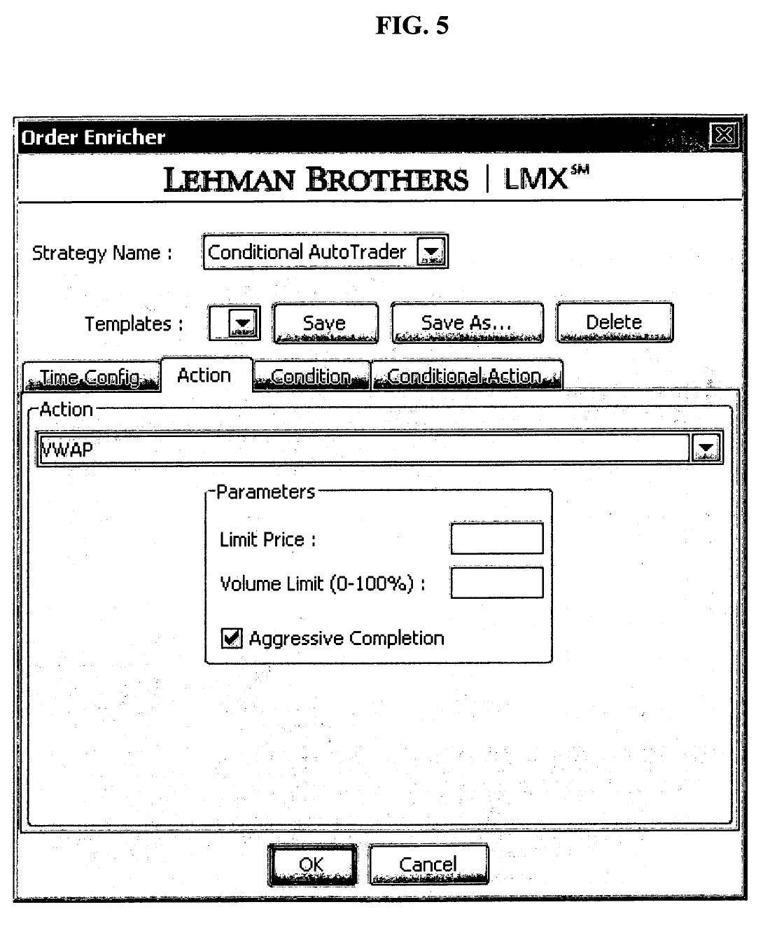

Action Tab: See FIG. 5. This tab is used to set the base action. The order will begin trading in this action state, and will remain in this state until the chosen condition is triggered. Available action choices include: VWAP, With Volume (percent of volume), Target Strike (arrival price impact minimization), TWAP (time-weighted average price impact minimization), and Idle.

The first four options are trading algorithms that also are available as stand-alone execution strategies. Each algorithm has a set of parameter options that can be used to set constraints and tailor the execution style. These parameters apply only to this action; they do not apply when the order is in the conditional action state.

Choosing the Idle action instructs CAT to take no action until the specified condition occurs. When the order is in an Idle state, CAT will monitor market conditions, but will not generate any orders.

Condition Tab: The Condition tab is used to define the scenario that will trigger the conditional action. Preferably, there are four types of conditions that can be set, each with its own set of parameters: Price Condition, Time Condition, Size on Opposite Side Condition, and Bid/Ask Spread Condition.

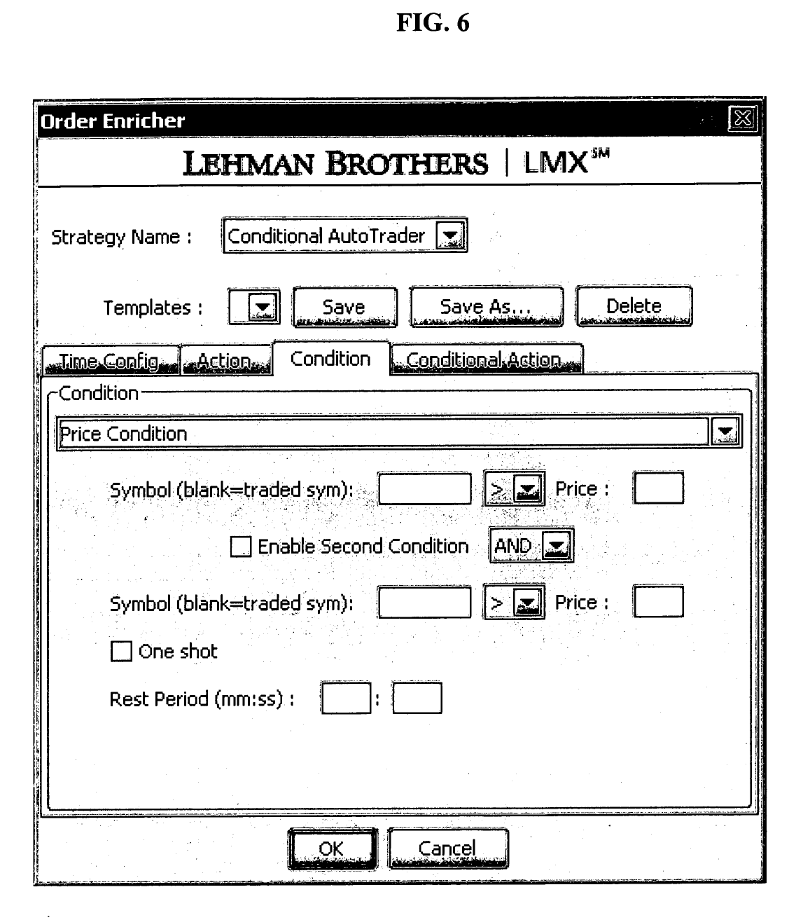

Condition Tab—Price Condition: See FIG. 6. A Price Condition can be used to monitor security prices and trigger the conditional action when threshold levels are reached. Any equity or futures security can be monitored, or the Symbol field can be left blank to indicate the order symbol. Securities should be specified by the standard ticker symbol assigned by the listing market.

If the Enable Second Condition box is checked, two price conditions can be combined. If the OR modifier is selected, then the condition evaluates to true when either of the two price thresholds are reached. If the AND modifier is selected, both price thresholds must be met for the condition to evaluate as true.

The One Shot and Rest Period parameters are discussed below.

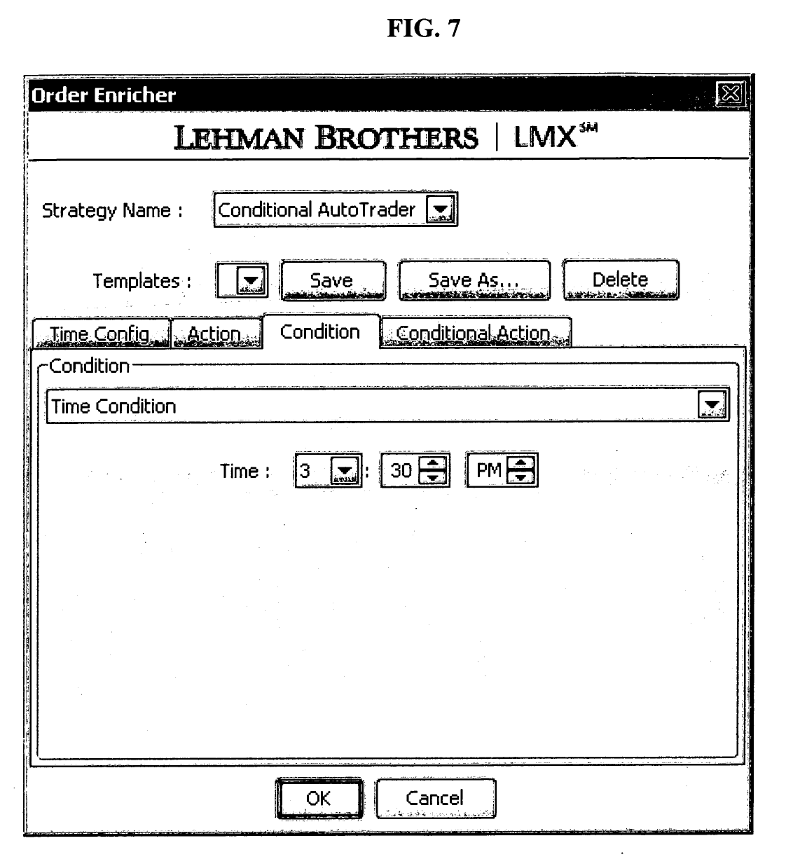

Condition Tab—Time Condition: See FIG. 7. Time can be used to trigger the conditional action. When the Time Condition is used, the order will trade with the base action until the specified time, at which point the conditional action will take over.

If the One Shot box is checked, then the transition will only occur once. If the One Shot box is not checked, the order will trade using the action until the specified time, and then cycle between the action and conditional action. The number of minutes between cycle transitions is defined using the Rest Period. For example, if the time is set to 1:15 PM and the Rest Period is set to 15 minutes, then the order will trade with the base action until 1:15 PM, then switch to the conditional action for 15 minutes (1:15-2:00 PM), then revert back to the base action from 2:00-2:15 PM, then switch over to the conditional action, and so on.

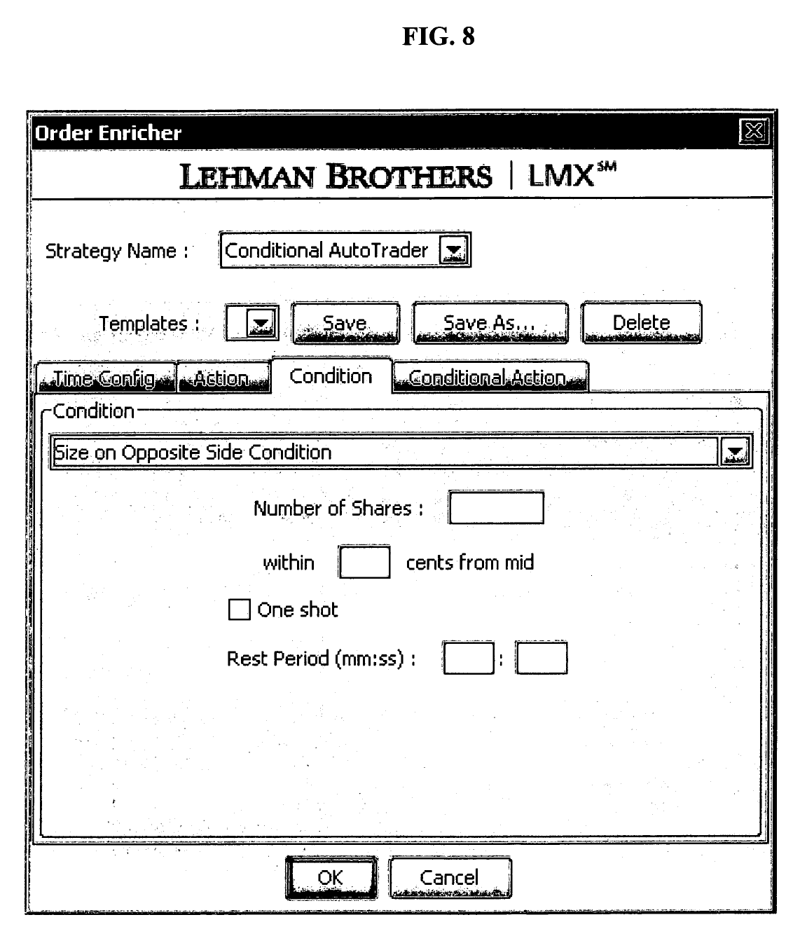

Condition Tab—Size on Opposite Side Condition: See FIG. 8. This condition can be used to watch for significant quoted size within a specified range of the spread midpoint. The conditional action will be triggered when at least the specified number of shares is available within the indicated number of ticks from a user-specified reference price, such as the bid-ask midpoint. The algorithm preferably will react to the aggregate of all significant displayed liquidity sources, scanning two ticks deep in each book up to a total of the three ticks closest to the reference price.

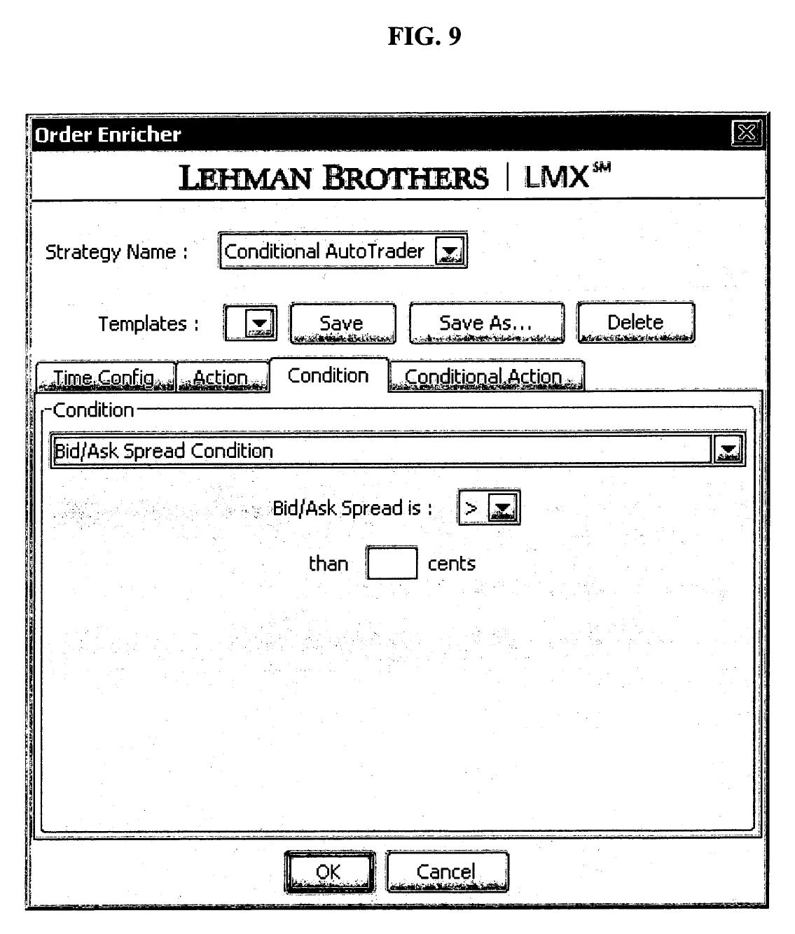

Condition Tab—Bid/Ask Spread Condition: See FIG. 9. This condition can be used to trigger the conditional action when spread is either wider than or narrower than the specified threshold level.

Unlike the other conditions, the Bid/Ask Spread Condition interface preferably does not allow users to set the One Shot or Rest Period parameters. Because of the flickering nature of quotes, the condition is always applied in a multi-shot capacity (i.e., with the One Shot parameter set to false) with a default Rest Period of 1 minute.

Condition Tab—the One Shot and Rest Period Parameters. The One Shot checkbox on the Condition tab is used to indicate whether the state transition should occur only once or more than once. Checking the One Shot box indicates that the transition to the conditional action state is a one-time, permanent switch (when the conditional action is set to Fast Exec, the One Shot and Rest Period parameters are interpreted differently; see the description of the Fast Exec action below for details). Leaving the One Shot box unchecked indicates that the order can cycle between the action and the conditional action.

One Shot Example: Trade using a With Volume algorithm and a 20% target rate. If the security price ever falls below $20 then increase to a 40% rate for the remainder of the order.

Cycling Example: Trade using a With Volume algorithm and a 20% target rate. Whenever the security is trading below $20 then increase to a 40% rate until the price rises above $20 again.

The Rest Period setting is used to specify the minimum amount of time that the order must spend in each action state after an action shift. Because Rest Period only applies after an action shift, there is no timing restriction on how soon the initial state change can occur. In other words, if the specified condition is true at the start of the time horizon, then the strategy can shift to the conditional action state immediately, regardless of the Rest Period setting. For example, if Rest Period is set to 2 minutes, then whenever the order switches state from base action to conditional action or vice versa, it must spend a minimum of 2 minutes in the new action state before considering switching back to the previous action. When the One Shot box is checked, the Rest Period is not applicable. Note that the algorithm does not literally rest during the rest period: at all times the order is active in either the base action or conditional action states. Also note that the behavior of the Rest Period parameter is different for the Time Condition, as described above.

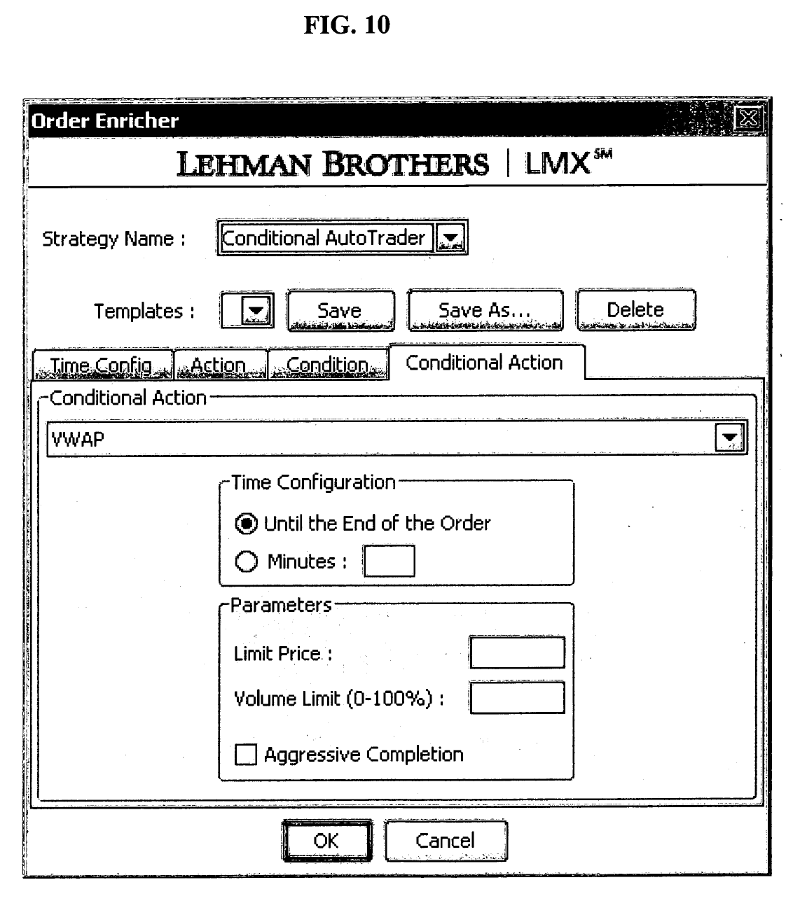

Conditional Action Tab: See FIG. 10. This tab is used to set the action that is triggered when the condition fires. Examples of available conditional action choices include: VWAP; With Volume; Target Strike; and TWAP algorithms; Idle; and Fast Exec.

The first four options are core trading algorithms that also are available as stand-alone execution strategies. Each algorithm has a set of parameter options that can be used to set constraints and tailor the execution style. These parameters only apply to this conditional action, they do not apply when the order is in the base action state.

Choosing the Idle action instructs CAT to do nothing but monitor the condition for as long as the specified condition occurs. When the strategy is in an Idle state, CAT will cancel open orders (if any) and then wait, monitoring market conditions but not generating any orders. If the One Shot box on the condition tab is checked and the Idle conditional action is selected then as soon as the condition fires, all open orders will be canceled and any unexecuted shares will be immediately returned to the trader.

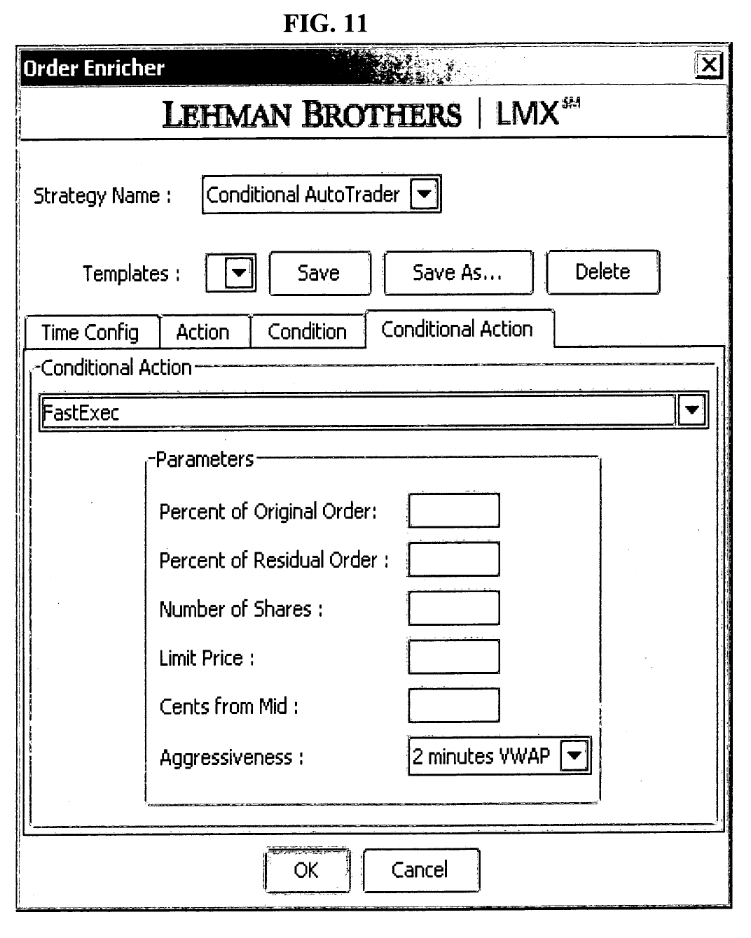

Conditional Action Tab—Using Fast Exec: See FIG. 11. The Fast Exec conditional action is used to execute up to a user-specified number of shares rapidly when the condition is triggered. The screen shows the different parameters that can be set with this action. The top three fields are used to set the size that will be grabbed when the condition triggers. A user can constrain the size by Percent of Original Order, Percent of Residual Order (remaining shares), or by entering an absolute Number of Shares. The user can set more than one of these three parameters, in which case the algorithm will choose the most conservative (smallest) constraint. The Fast Exec sweep size is always automatically constrained by the number of unexecuted shares to prevent an overtrade.

The Cents from Mid box is used to specify the number of cents beyond the midpoint of the bid-ask spread that a user is willing to pay to grab liquidity. Note that this parameter can be specified more generally as a number of ticks, for application to non-US markets. The user also can set a hard Limit Price for additional price protection. The user can set either or both of these two price constraints. If both constraints are set, then the most passive (conservative) of the two price constraints will apply.

Fast Exec can use either of two techniques to grab liquidity. The size and price constraints discussed above apply to both techniques.

(1) Limit Sweep will aggressively sweep liquidity (i.e. execute against posted orders in the order book) orders from the order book up to the selected size and selected price. If there are residual shares, they will be posted briefly (5 seconds for NASDAQ stocks and 45 seconds for listed stocks) and then canceled.

(2) 2 Minutes VWAP will trade the desired size over 2 minutes using an aggressive VWAP algorithm.

As soon as the chosen technique has run its course, the strategy will immediately revert back to the base action state regardless of whether the One Shot box is checked.

Preferably users receive the following warning if they select Fast Exec as their conditional action: “Warning: Fast Exec is a powerful action and must be used carefully! If the price and size constraints are not set properly, this action can cause significant market impact. Rest Period (on the Condition tab) must also be set appropriately to avoid invoking Fast Exec too frequently. Finally, before using a Fast Exec action, be sure you fully understand how the One-Shot and Rest Period condition parameters operate in conjunction with it.”

Fast Exec is unlike other actions in that its activity occurs at a focused point in time instead of over a longer horizon. Because of this, the One Shot and Rest Period parameters (found on the Condition tab) are used in a slightly different way when the conditional action is set to Fast Exec. If the One-Shot box is checked, then when the condition is triggered the Fast Exec action will grab liquidity once and then return to the original action for the remainder of the trade. If One-Shot is not checked, then whenever the condition is triggered (subject to having satisfied the Rest Period parameter, described below), the strategy will grab liquidity using Fast Exec and then return to the base action. In this case, the Rest Period is used to tune the frequency with which Fast Exec can fire. For example, if Rest Period is set to 90 seconds, then the strategy cannot invoke the conditional action until 90-seconds have elapsed since the last time the conditional Fast Exec action completed.

Cycling Fast Exec Example: Execute a buy order using a VWAP algorithm as the base action. Whenever 5000 shares is available on the offer side within 2 cents of the spread midpoint, trigger Fast Exec and then immediately return to the VWAP algorithm. Never grab liquidity more frequently than 2 minutes after the previous Fast Exec action has completed.

More CAT Strategy Examples

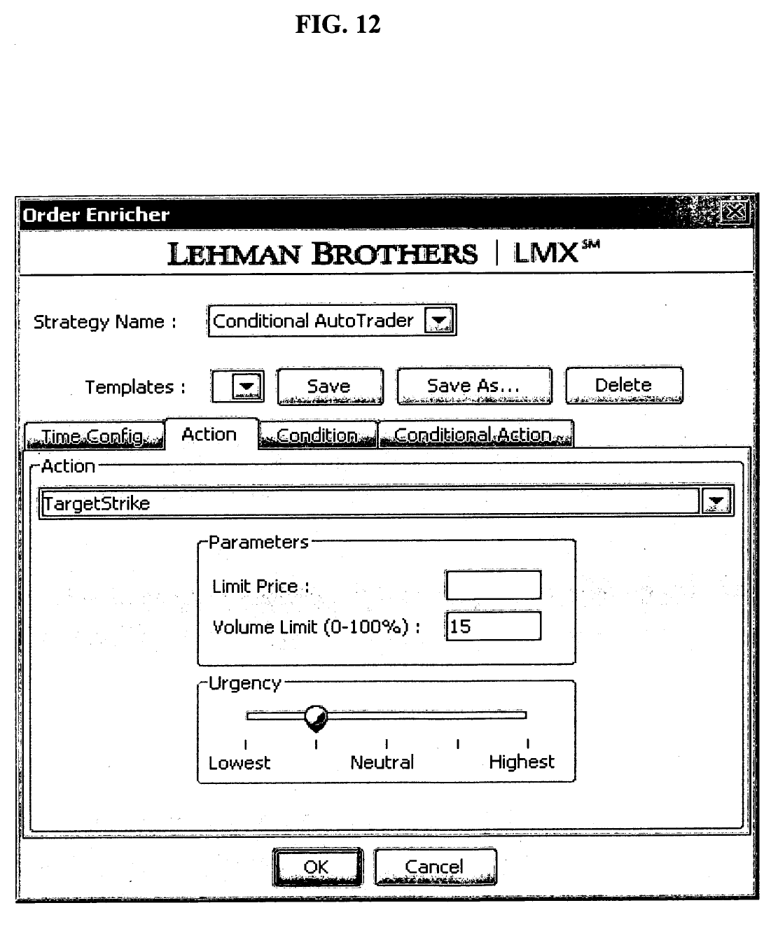

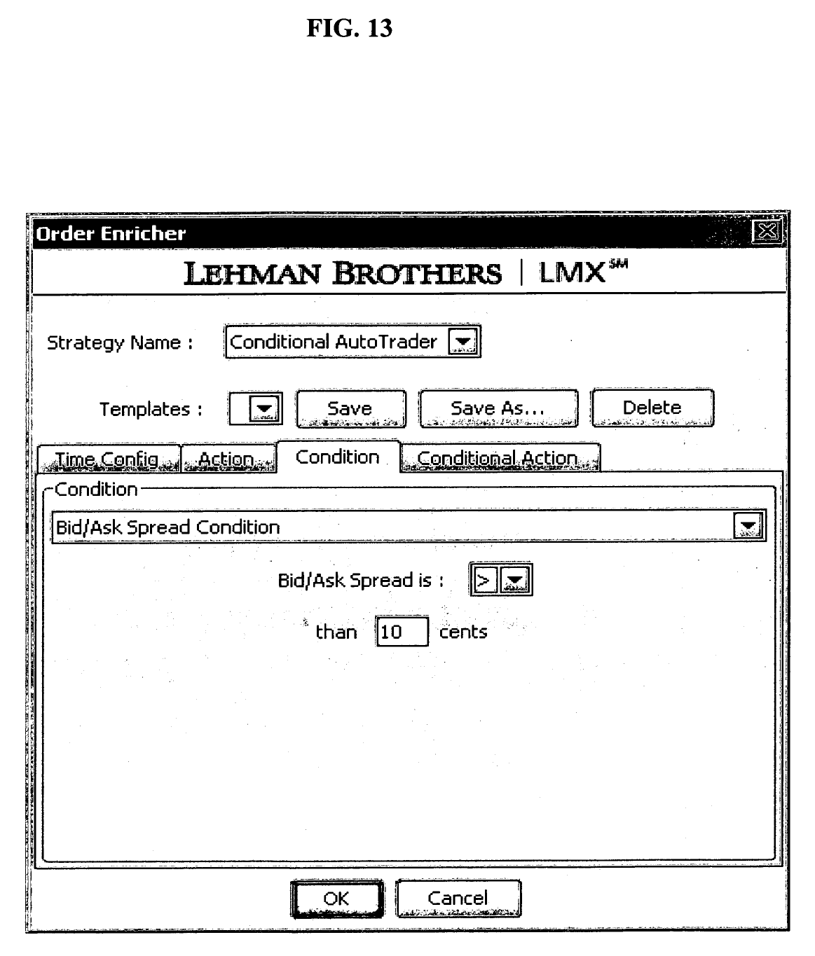

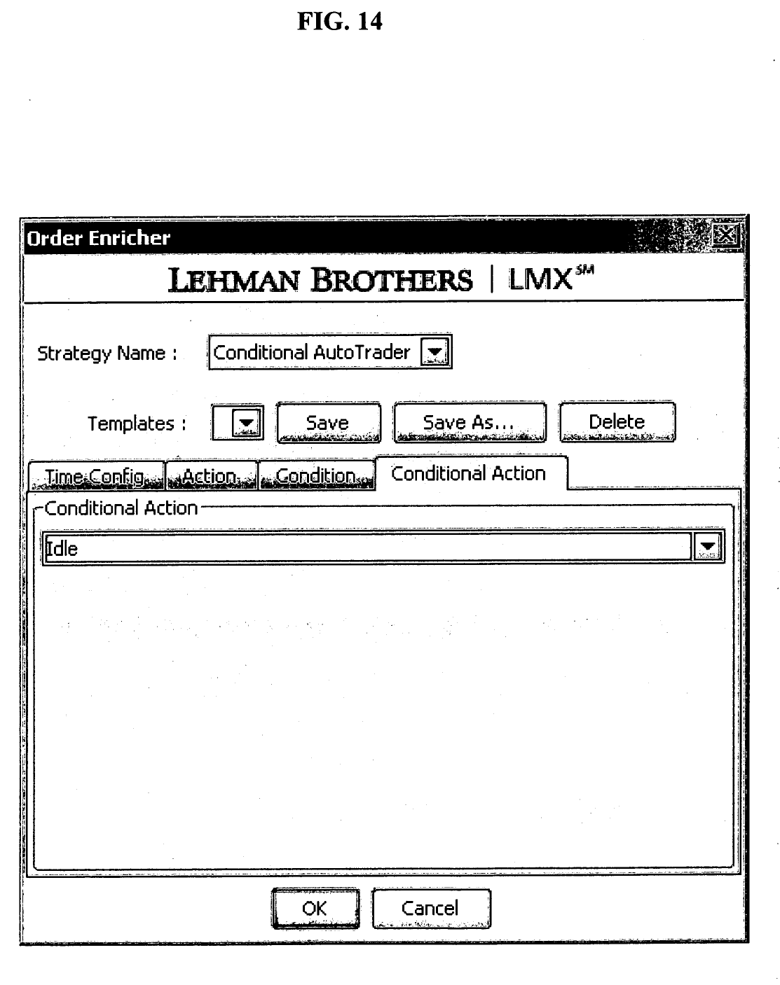

Stealthy Target Strike: Work the order using an optimal schedule (i.e., one that balances price impact and price risk; see FIG. 12), but whenever spreads widen beyond 10 cents (see FIG. 13) cancel orders and wait for the order book to fill in (see FIG. 14).

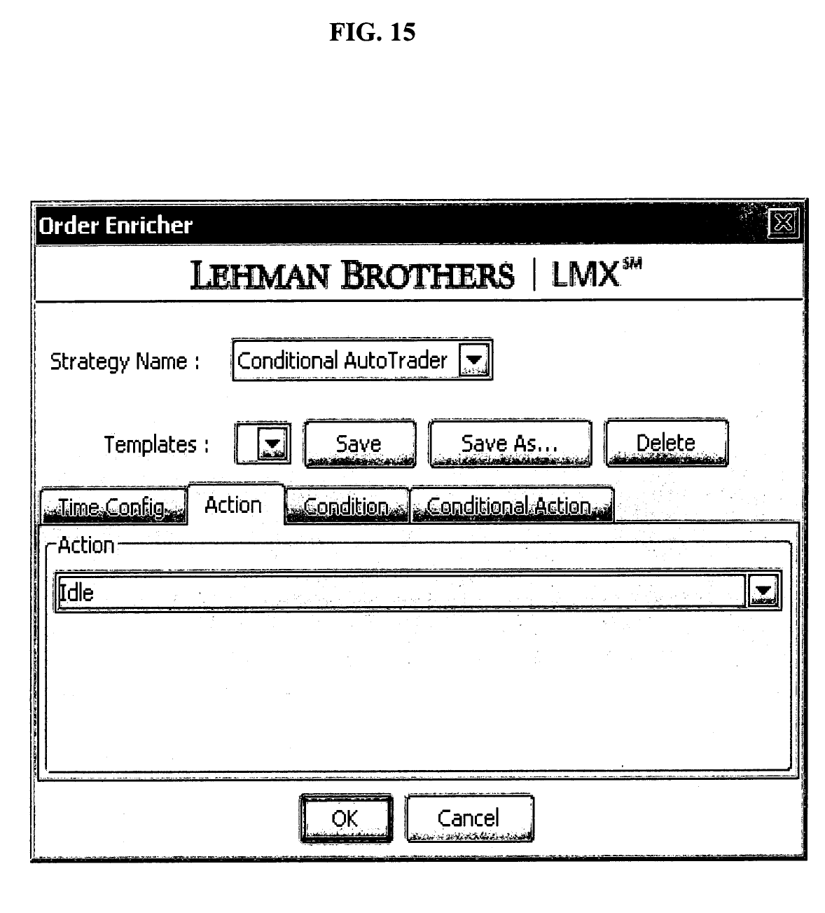

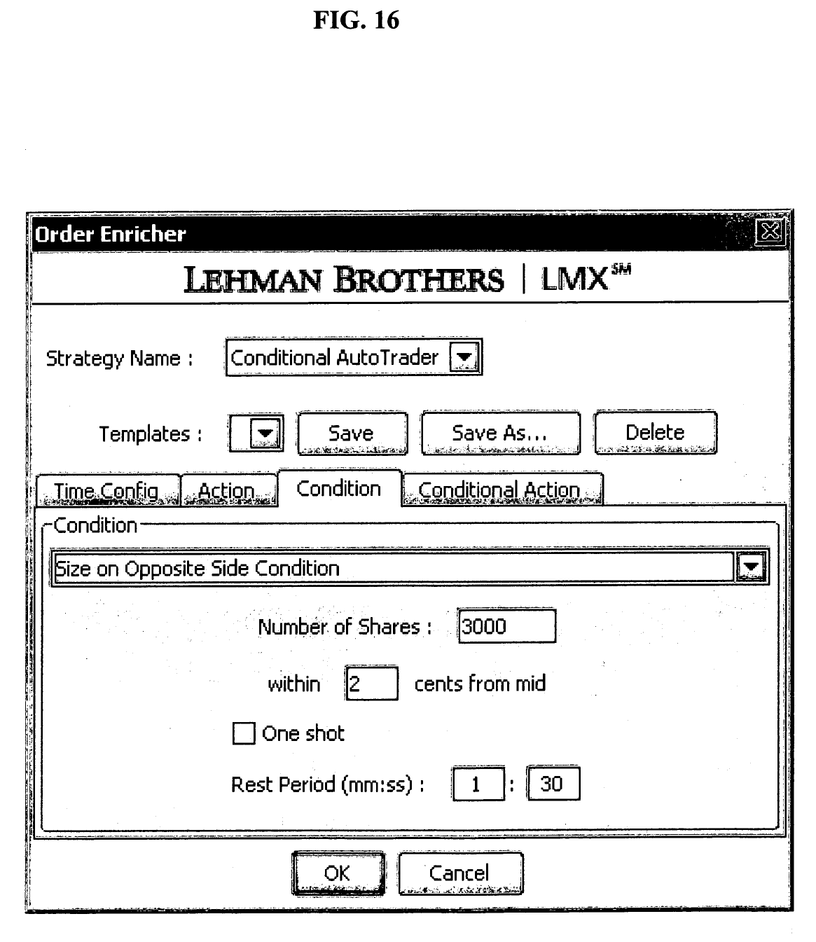

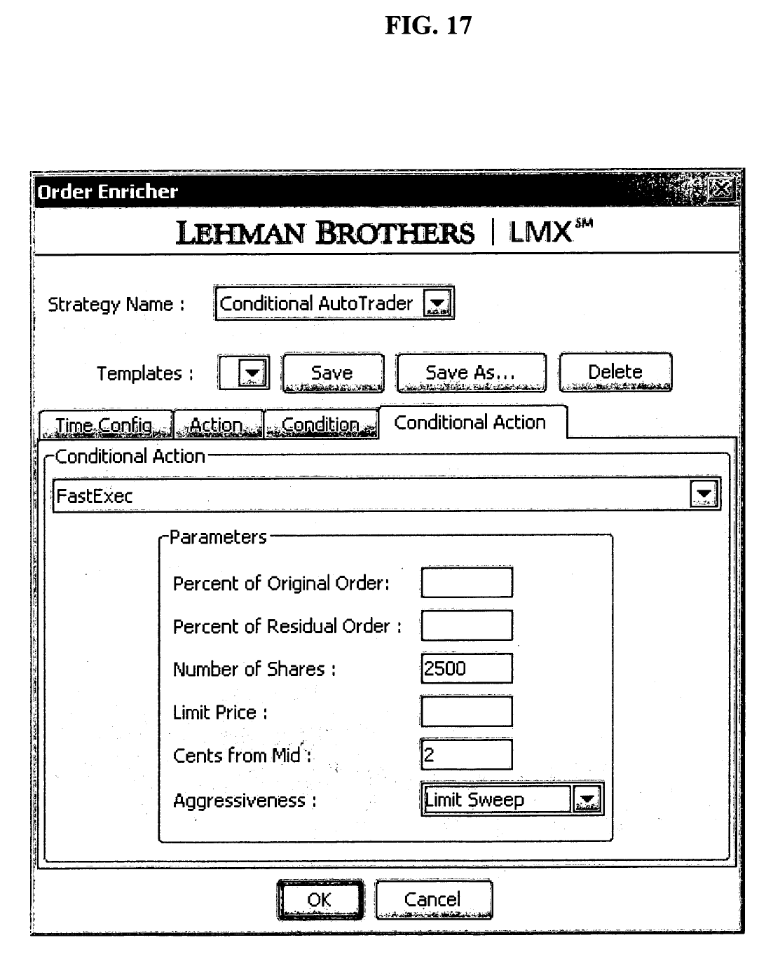

Lurk and Pounce: Lie in wait using the Idle action (see FIG. 15) until significant depth shows up within range (see FIG. 16), and then sweep the book using Fast Exec (see FIG. 17).

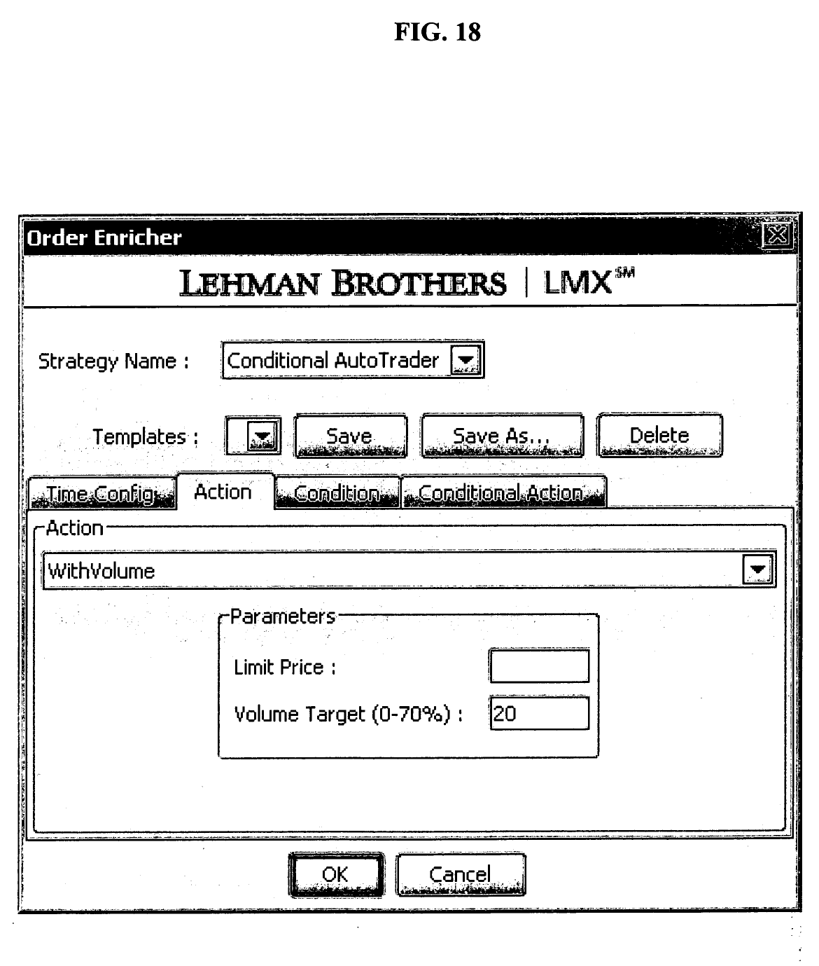

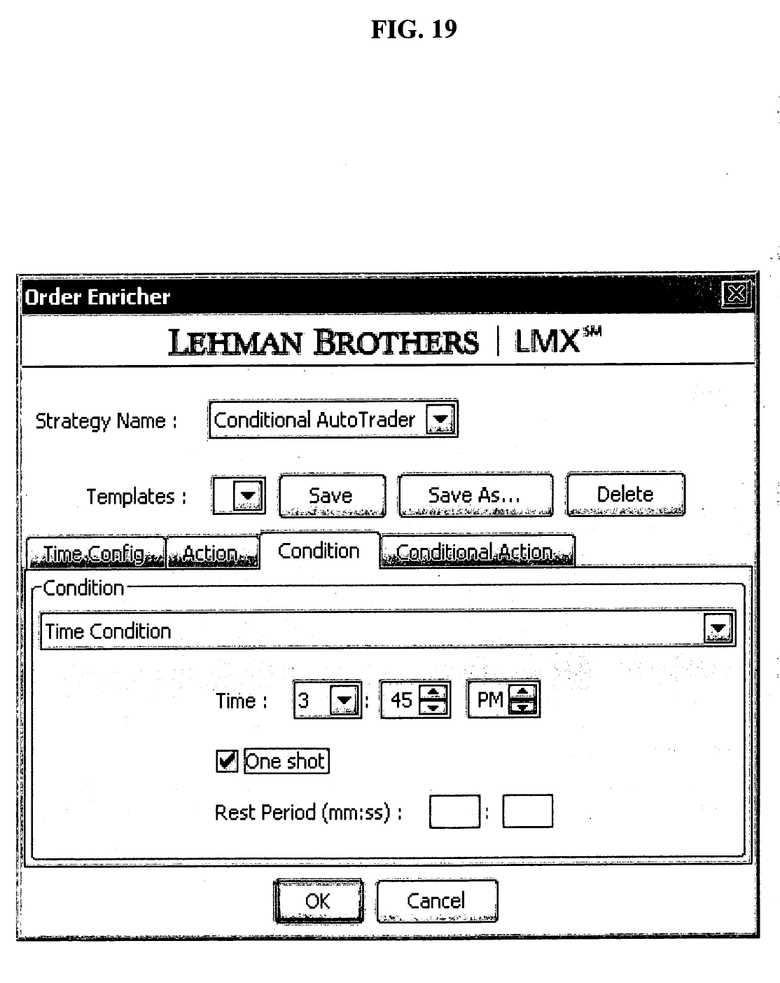

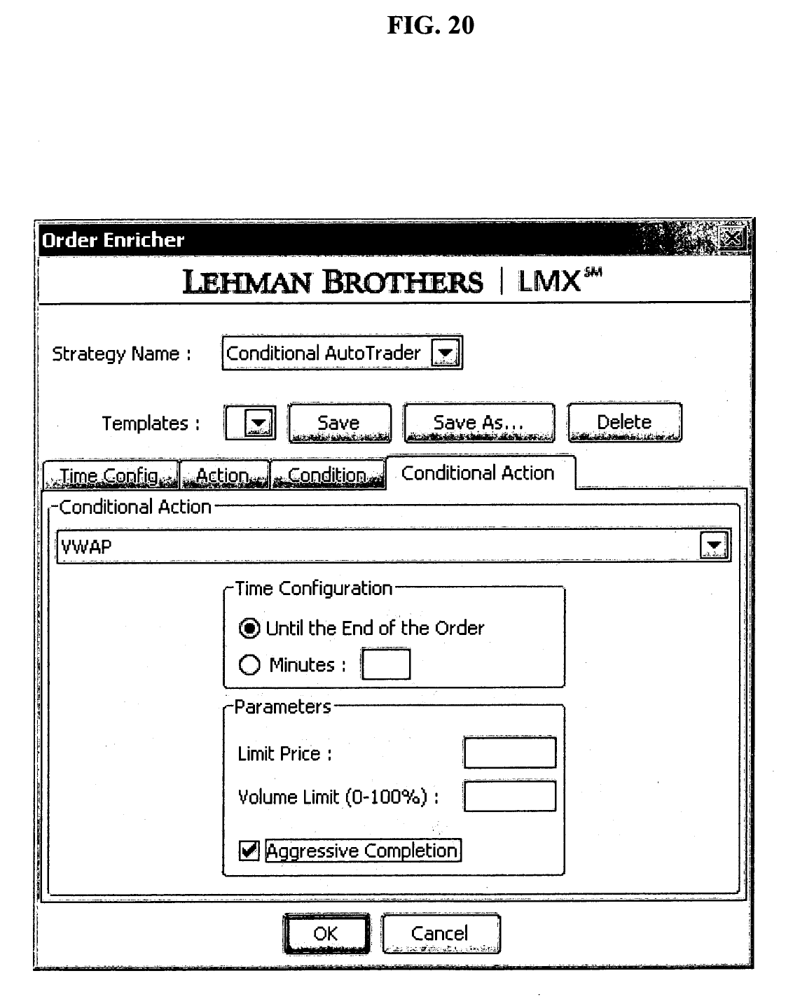

With Volume with 3:45 PM Clean-Up: Participate at a rate of 20% of traded volume using the With Volume algorithm (see FIG. 18), but if the order is not complete by 3:45 PM (see FIG. 19) clean up with a 15-minute VWAP algorithm (see FIG. 20).

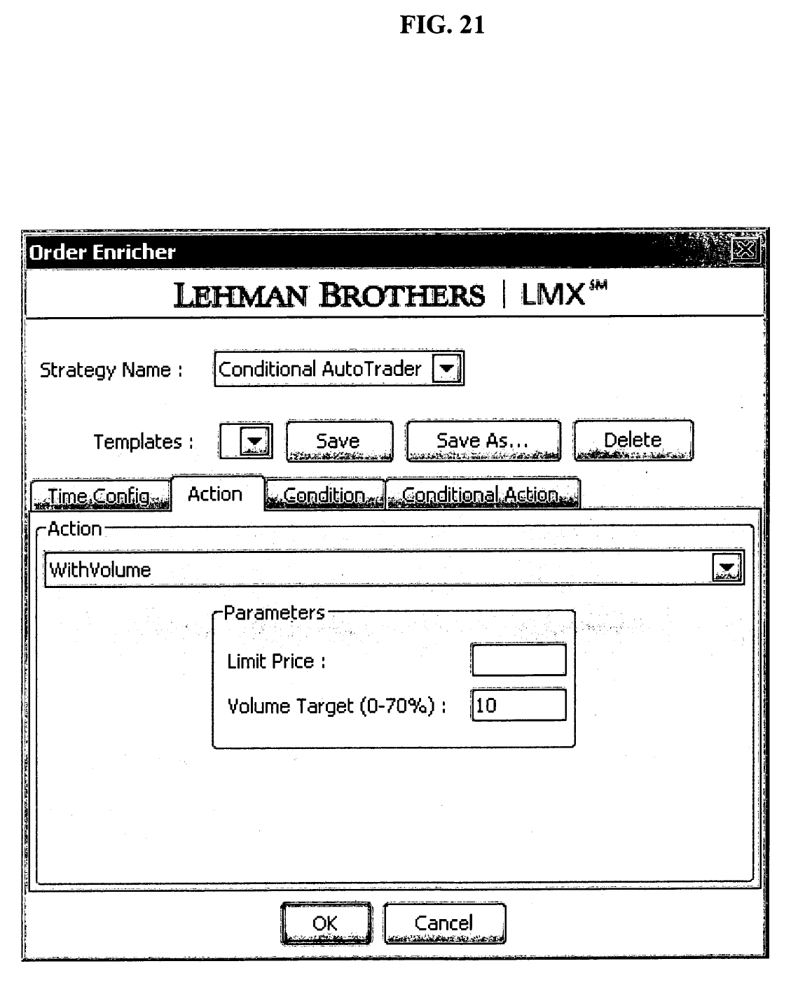

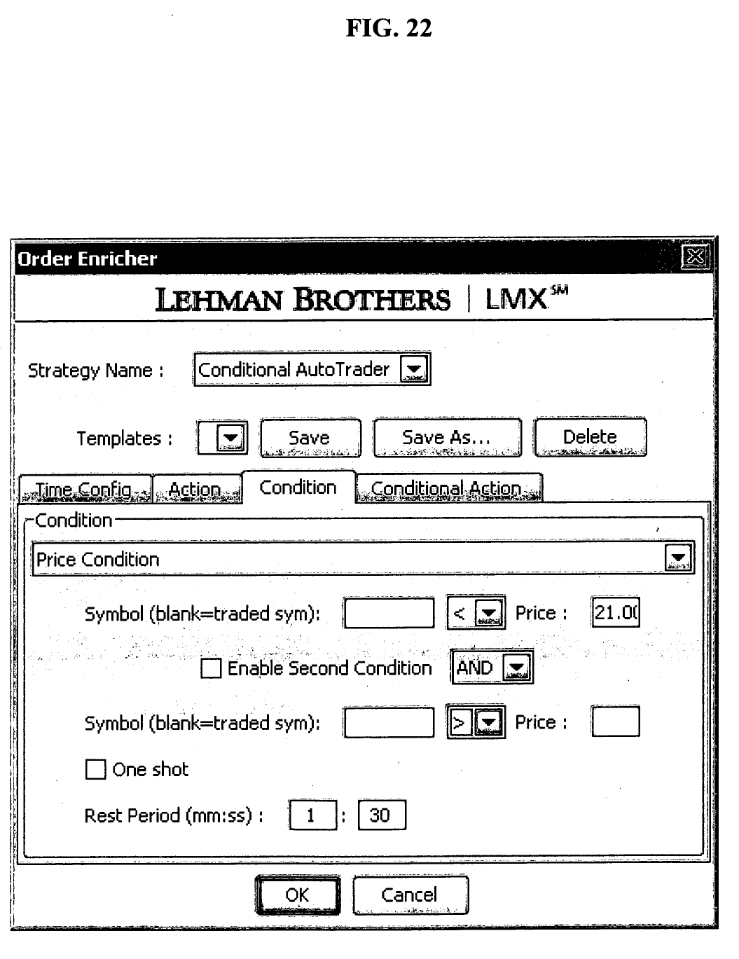

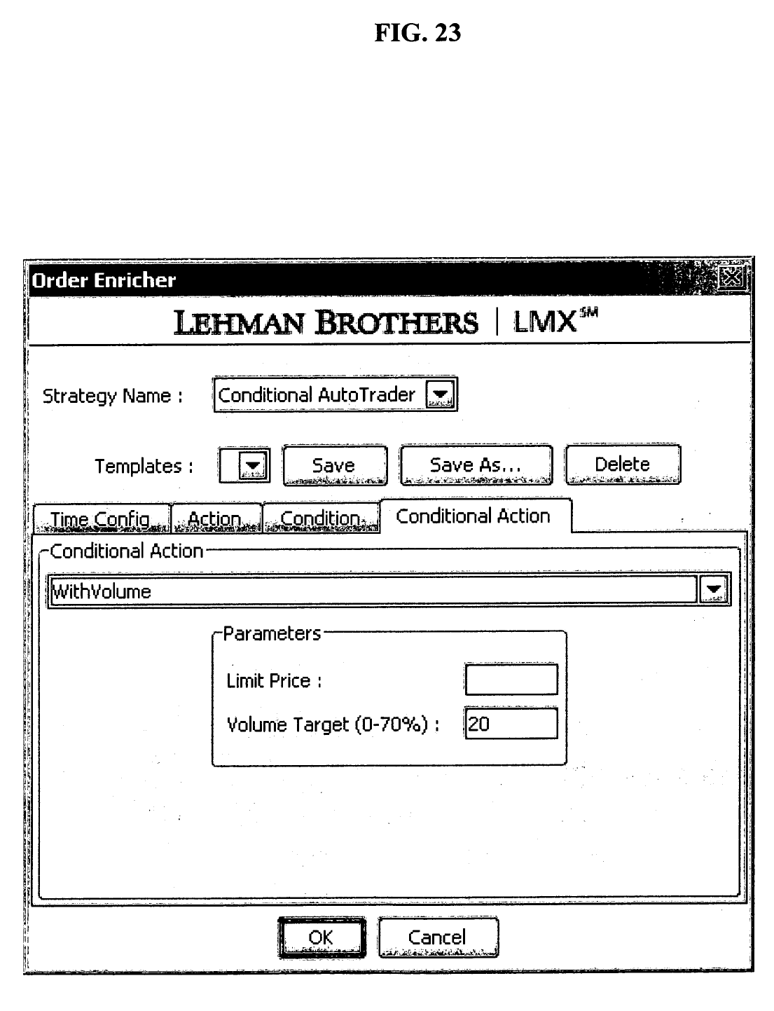

Scaled With Volume: Participate at a rate of 10% of traded volume using the With Volume Algorithm (see FIG. 21), but whenever price falls below $21.00 (see FIG. 22) increase the rate to 20% of traded volume (see FIG. 23).

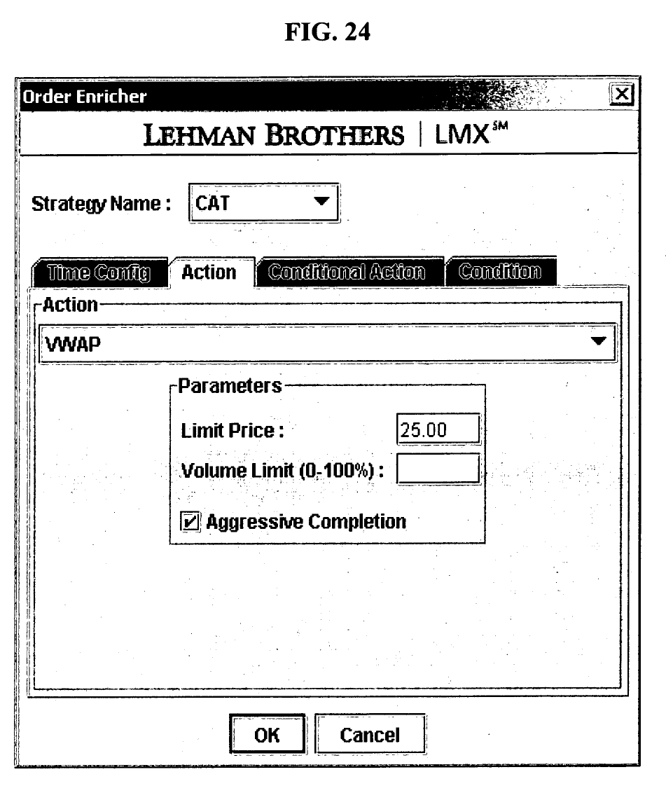

In another illustrative example, a trader wishes to work an order with a VWAP style over a specified time horizon. Referring to FIG. 24: the selected base action is “VWAP”; the selected limit price is 25.00, and the Boolean “Aggressive Completion” parameter has been set to True (i.e., the box is checked).

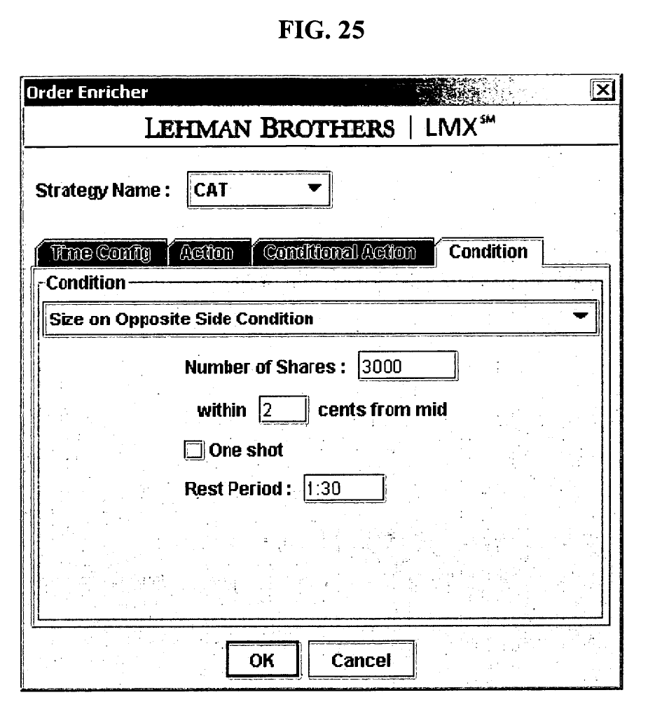

Referring to FIG. 25: the trader also wishes to monitor the market to watch for unusual liquidity within a specified price range, and thus has selected the Condition of “Size on Opposite Side Condition”; selected number of shares to be “3000”; selected the price range to be “within 2 cents from mid,” and selected a Rest Period of one minute thirty seconds.

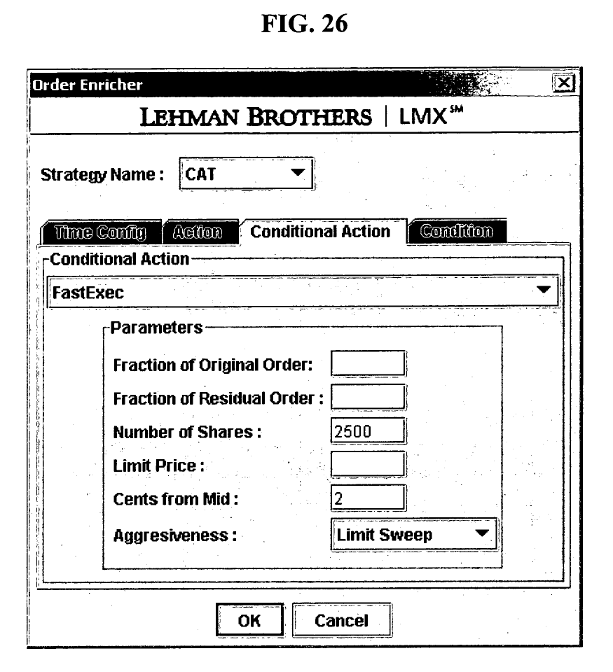

Referring to FIG. 26: the trader wishes to react to that liquidity with an intelligent sweep. If desired, the original trading strategy can resume (after a configurable delay). Thus, the trader has selected a Conditional Action of “Fast Exec”; a Number of Shares of “2500”, a price range of 2 cents from the bid-ask midpoint; and an aggressiveness of “Limit Sweep.”

Other Embodiments

In a re-usable strategies embodiment, the user does not need to re-enter Actions or Conditional Actions, for example, for a sequence of securities to which designated strategies are to be applied—the same parameters can be re-used. Instead of a Price condition, for example, the user may select a Relative Price condition (i.e., instead of a Price level triggering a change in strategy, a percent change in price may be the trigger) that may be used several times for various securities.

In a savable strategies embodiment, a user may save some or all parameters (particularly parameters such as a Relative Price condition) under a user-defined name, so those parameters can be recalled and re-used at will, without those parameters needing to be re-entered.

In one embodiment, a user may ask to be alerted when the system has switched from one strategy to another or upon the occurrence of some other event relevant to operation of the auto-trading system.

In another embodiment, a user is provided with a display that enables the user to quickly see which strategies are being used for each security being traded. For example, if strategies A and B are being used, the display may have a column listing orders in securities and indicating to which order strategy A is being applied and to which order strategy B is being applied. In another example, the display may have a column for strategy A and a column for strategy B, wherein orders in securities are listed across both columns, and indications are provided in column A for an order to which strategy A is being applied and in column B for an order to which strategy B is being applied.

After a hybrid strategy has been built using the interface as previously described, the new hybrid strategy can be stored and then subsequently recalled and implemented to execute securities trades. The hybrid strategy is preferably represented using a markup language that may be stored and recalled from a computer-readable medium such as, for example, a semiconductor, magnetic or optical storage device. The markup language preferably represents each parameter of a trading strategy by a key-value pair where the key identifies a parameter and the value is the value of the parameter. The final component of the system is an automated trading engine configured to read the represented hybrid strategy, generate the trading orders to implement the strategy, and submit the generated orders to an order routing system for execution in the desired exchange. The engine executes over the time interval defined in the strategy, switching states between the selected Action and Conditional Action based on the selected Condition settings.

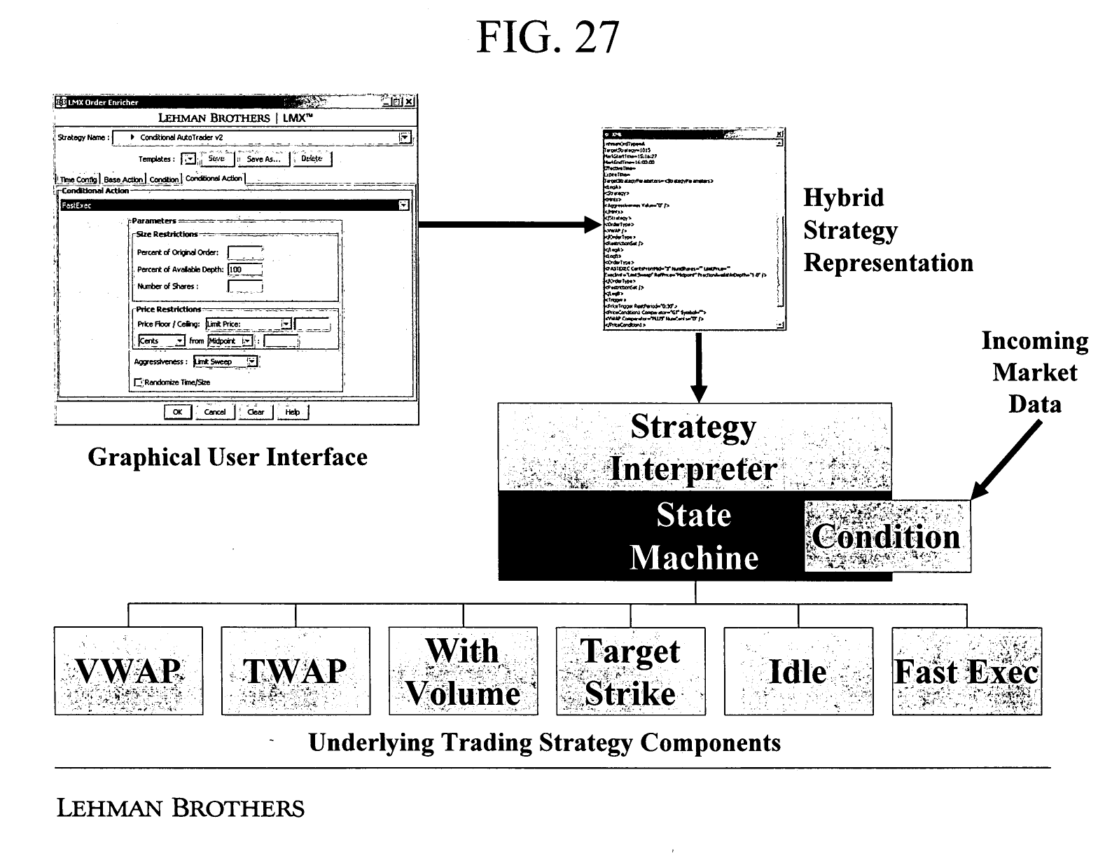

FIG. 27 is a component diagram of an embodiment of the present invention. In FIG. 27, an interface builds hybrid strategies out of a set of building blocks that include actions and conditions. As previously described, these actions are typically trading algorithms that may also be available as stand-alone trading strategies, and will often be well-known to those skilled in the art. Conditions are event triggers that switch between actions depending on real-time market events. The CAT interface described in this document provides such an interface. A module converts the data collected by the interface and generates a representation of the hybrid strategy that may be stored on a computer-readable medium and retrieved by the interpreter for execution.

A strategy interpreter retrieves hybrid algorithms that have previously been stored and converts them into a set of machine instructions defining a set of actions and conditions, as well as a timeframe for the order. A state machine that has access to a set of actions routes orders to these actions in accordance with the machine instructions loaded from the hybrid strategy.

The state machine may use a set of specified conditions to determine which action should be active at any given time, and will then route the order (or a portion of the order) to this active action for automated execution.

The underlying trading strategies that make up the family of actions available to the state machine are used to execute orders according to a set of local instructions passed from the state machine. These trading strategies are utilized by the invention to deliver orders to the market. Those skilled in the art will be familiar with the various trading strategies that could be used as components in the action set.

After a hybrid strategy has been built using the interface as previously described, the new hybrid strategy can be stored and then subsequently recalled and implemented to execute securities trades. The hybrid strategy is preferably represented using a markup language that may be stored and recalled from a computer-readable medium such as, for example, a semiconductor, magnetic or optical storage device. The markup language preferably represents each parameter of a trading strategy by a key-value pair where the key identifies a parameter and the value is the value of the parameter.

A strategy interpreter converts the encoded strategy into a set of machine instructions that defines the set of actions to be included in the hybrid strategy; any required parameter values for each action that are to be passed to the action at run time; the set of conditions to be used to determine when and how to shift between active strategies based on market events; and the desired time frame for the order.

The final component of the system is a state machine that guides trading based on the hybrid strategy definition. Specifically, this state machine has access to a collection of actions, which are generally underlying trading strategies. For example, in the CAT state machine, there are six actions: VWAP, TWAP, With Volume, Target Strike, Idle, and FastExec. Each of these actions is an automated trading strategy with access to trade on external securities markets. Each action has a set of parameters that are used to guide its behavior. The definition of the hybrid strategy contains a set of actions as well as a full definition of desired parameter values for each action.

The hybrid strategy definition also includes definitions of each condition to be used. The set of conditions collectively define the event(s) to be monitored; the criteria under which certain events should trigger a state change; and the specific action to be invoked for each possible state change. Given these definitions, the state machine is responsible for monitoring the specified real-time events (typically using a real-time market data feed); evaluating these events given the specified criteria; and effecting the specified state change when the specified criteria are met. A state change is effected by passing control over the order to a new action. Typically, this means cancelling an order from the previous action and sending an order to the new action.

Finally, the state machine must ensure that the time configuration parameters in the hybrid strategy definition are met. This means commencing trading at the desired start time and closing out the trade at the desired end time (cancelling orders and returning any unexecuted shares back to the user.)

The CAT interface description provides details on the types of actions and conditions that can be utilized to create hybrid strategies, as well as the way in which state changes are effected.

The set of actions (typically a set of trading algorithms accessible by the state machine) is responsible for the actual execution of orders. These actions have access to external markets and logic that determines how to make all trading microdecisions (order timing, order placement, and subsequent correction/cancellation) according to any instructions passed in from the state machine.

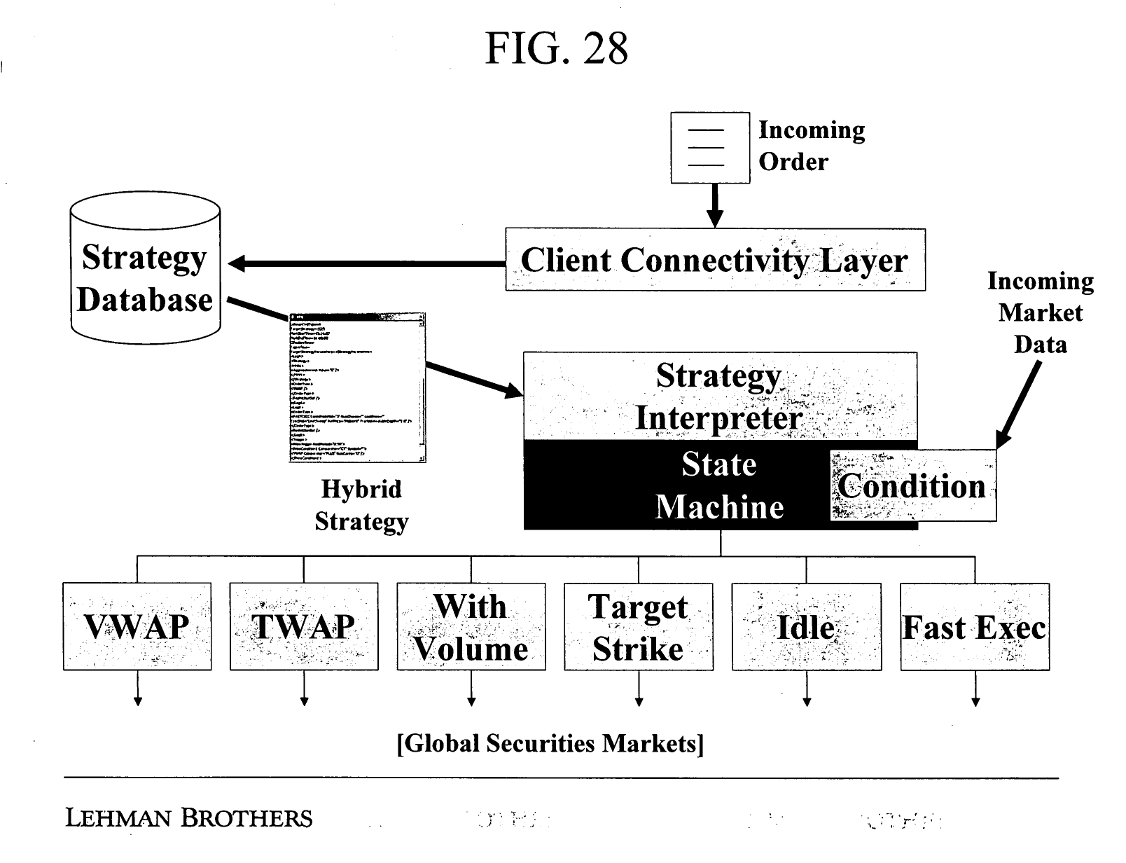

FIG. 28 illustrates a typical workflow for executing a hybrid order in some embodiments of the present invention. An incoming order arrives at the system and is processed by a client connectivity layer that determines what hybrid strategy is to be used to execute the order, and then retrieves a representation of this hybrid strategy from a strategy database. The hybrid strategy is then processed by an interpreter which converts the encoded strategy to a set of machine instructions. The state machine then implements the instructions, monitoring the desired condition(s) to determine how to shift state between the specified set of actions. The condition(s) rely on real-time market data to generate events. The set of available actions consists of a set of trading algorithms with access to external securities markets and the ability to execute orders.

Those skilled in the art will be familiar with the various trading strategies that can be implemented with CAT, including the strategies explicitly mentioned herein. However, for those not skilled in the art, some additional information regarding some of the more easily explained strategies is provided below.

VWAP stands for volume-weighted average price. This is the average price for the stock over a specified time horizon, with more weight given to periods of heavier trading. The VWAP over any time period is the result of dividing total dollar volume by total share volume over that time period.

TWAP stands for time-weighted average price, and is a simpler way of averaging a stock price over a specified time period. Calculating a TWAP entails dividing the time period into intervals (e.g., minutes), taking a snapshot of the stock price at the end of each interval, and then averaging those interval prices. No extra weight is given to any one interval, even if an extraordinary number of shares were traded during that interval.

The main goal of a VWAP strategy is to minimize slippage relative to the VWAP benchmark over the selected time period. This is achieved by constructing a trading profile that matches expected market liquidity over time and allocating a greater share of the order to the periods of the day that typically attract the highest levels of market activity. The strategy releases slices of the order using this trading profile as a roadmap and continuously monitors short-term indicators to optimize order timing and pricing.

The goal of the TWAP strategy is to trade with minimal shortfall relative to a TWAP benchmark. The TWAP strategy trades at a constant rate during the time period, participating evenly so that the percent of the order that is filled at any time during the period matches the percentage of the time period that has elapsed.

Thus, the TWAP strategy trades at a rate linearly proportional to elapsed time, spreading the trade evenly across a time period. On the other hand, the VWAP strategy tracks an expected volume profile, overweighting the portions of the day that correspond to heaviest trading.

Various embodiments described herein are not intended to be mutually exclusive; those skilled in the art will recognize that various combinations of these and other embodiments are within the scope of the invention.

While particular elements, embodiments, and applications of the present invention have been shown and described, it should be understood that the invention is not limited thereto, since modifications may be made by those skilled in the art, particularly in light of the foregoing teaching. For example, although the embodiment described in FIGS. 1-26 show a single base action and a single condition, it should be understood that modifications to add additional base actions and conditions may be made by those skilled in the art and are within the scope of the present invention. The appended claims are intended to cover all such modifications that come within the spirit and scope of the invention.

We claim:

1. A computer system operable to display a graphical user interface comprising a time horizon component, a base action component, a condition component, and a conditional action component, wherein
said time horizon component is operable to display a start time and an end time for a trading order for a security;
said base action component is operable to display information identifying one or more automated trading strategies to be initially used to execute said order;
said condition component is operable to display one or more market conditions for triggering one or more triggered strategies; and
said conditional action component is operable to display information identifying said one or more triggered strategies to be used to execute said order when triggered by said one or more market conditions.

2. The system of claim 1, wherein said time horizon component comprises a time configuration tab display.

3. The system of claim 2, wherein a default start time is immediately.

4. The system of claim 2, wherein a default end time is time of market closing.

5. The system of claim 1, further comprising a one shot component that allows a user to specify that a transition from an action to a conditional action occurs only once.

6. The system of claim 1, further comprising a rest period component that displays at least a time period that an order must spend in an action after an action shift.

7. The system of claim 1, further comprising a rest period component that displays at least a time period that must elapse following completion of an action before that action can occur again.

8. The system of claim 1, wherein said base action component comprises an action tab.

9. The system of claim 1, wherein said base action component is operable to display trading strategies comprising one or more of: VWAP, With Volume, Target Strike, TWAP, and Idle.

10. The system of claim 1, wherein said one or more market conditions comprise passage of time.

11. The system of claim 9, wherein said base action component is further operable to display one or more sets of parameter options operable to set one or more constraints and tailor execution style for at least one of said trading strategies.

12. The system of claim 1, wherein said condition component comprises a condition tab.

13. The system of claim 1, wherein said condition component is operable to display conditions comprising one or more of: price condition, time condition, size on opposite side condition, and bid/ask spread condition.

14. The system of claim 13, wherein said condition component is further operable to display one or more parameters for at least one of said conditions.

15. The system of claim 13, wherein said price condition is operable to trigger a conditional action when said security's price reaches a threshold level.

16. The system of claim 13, wherein said time condition is operable to trigger a conditional action at a specified time.

17. The system of claim 13, wherein said size on opposite side condition is operable to trigger a conditional action when at least a specified number of shares is available within a specified range of a midpoint of a bid/ask spread.

18. The system of claim 13, wherein said bid/ask condition is operable to trigger a conditional action when a bid/ask spread is wider or narrower than a specified threshold level.

19. The system of claim 1, wherein said conditional action component comprises a conditional action tab.

20. The system of claim 1, wherein said conditional action component is operable to display conditional actions comprising one or more of: VWAP, With Volume, Target Strike, TWAP, Idle, and Fast Exec.

21. The system of claim 20, wherein said conditional action component is further operable to display one or more parameters for at least one of said conditional actions.

22. The system of claim 20, wherein said Fast Exec condition comprises one or more of: a Limit Sweep condition and a 2 Minutes VWAP condition.

23. A system for building and executing a hybrid trading strategy, the system comprising:
a user interface configured to build the hybrid trading strategy based on input provided by a user through the user interface;
an interpreter configured to convert a representation of the hybrid strategy into one or more machine instructions defining a set of actions and conditions for an order; and
a state machine configured to route the order to an underlying trading strategy based on the set of actions and conditions.

24. A method of executing a hybrid trading strategy comprising:
building a hybrid strategy, the hybrid strategy including a base action, a trigger condition, and a conditional action;
executing the base action; and
executing the conditional action when the trigger condition occurs.

25. The method of claim 24 wherein the base action is an automated trading strategy.

26. The method of claim 24 wherein the trigger condition is an external market event.

27. A method comprising:
selecting a base action from one or more automated trading strategies;
setting a trigger condition; and
selecting a conditional action from one or more automated trading strategies,
wherein the base action is executed until the trigger condition is met whereupon the conditional action is executed.

28. A method comprising:
providing one or more automated trading strategies for selection by a user as a base action;
providing one or more events for selection by a user as a trigger condition; and
providing one or more automated trading strategies for selection by the user as a conditional action,
executing the base action; and
executing the conditional action after the trigger condition is met.
